(19) United States
(12) Patent Application Publication
(10) Pub. No.: US 2003/0120687 A1
(43) Pub. Date: Jun. 26, 2003

(54) System and method of providing customized marketing data

(76) Inventors: G. Douglas Solomon, South Orange, NJ (US); Susan J. Wolff, Mt. Lakes, NJ (US)

Correspondence Address: LAMORTE & ASSOCIATES P.C., P.O. BOX 434, YARDLEY, PA, 19067, US

(21) Appl. No.: 10/348,891

(22) Filed: Jan. 23, 2003

Related U.S. Application Data
(63) Continuation-in-part of application No. 09/476,528, filed on Jan. 3, 2000.

(51) Int. Cl. G06F 7/00

(52) U.S. Cl. 707/200

(57) ABSTRACT

A system and method for dynamically providing marketing data to paying customers, without having to commission a new market survey for each customer. A marketing survey is created for each of a variety of different industries. Each of the surveys is distributed to potential respondents over a computer network. The same computer network is used to collect survey answers from participating respondents. The received answers are used to create marketing databases for different industries. Each customer is provided the ability to view the relationship between the answers of any two selected survey questions through the form of a customized data table.

### RELATED APPLICATIONS

This application is a Continuation-In-Part of copending application Ser. No. 09/476,528, entitled System And Method Of Providing Customized Marketing Data, which was filed on Jan. 3, 2000.

### BACKGROUND OF THE INVENTION

1. Field of the Invention

The present invention relates to software systems that are used to collect survey data, manipulate that data and present the collected data for marketing analysis. More particularly, the present invention relates to such software systems where the analysis of marketing data can be customized to fit the needs of individual users.

2. Description of the Prior Art

Many different types of companies rely upon marketing data to make business decisions. Although not guaranteed, a decision based upon solid marketing data is more likely to be correct than decision based upon no empirical data at all.

Traditionally, companies obtain marketing data by conducting surveys of their customers or potential customers. The survey may be conducted by the company itself, or may be done through an independent marketing company. In commissioning a survey, a company first decides what questions to put into the survey. The questions are designed to solicit specific answers that are useful as empirical data. Once the raw data is collected, the data must then be tabulated and delivered to the customer. As such, it is not uncommon for results to be delivered to a client several days after the survey has been completed.

As is often the case, each time a company collects marketing data, the survey used is wholly or partially different from other surveys they had used in the past. Accordingly, it is difficult to accurately compare the results of one survey to the result of a different more recent survey. Another problem with marketing data is that the data quickly becomes obsolete. For example, if a company wants to collect marketing data on current customer satisfaction, survey results from last year do not accurately contain this information. Consequently, companies almost always commission a new survey, each time they desire data to make a specific business decision. The costs involved in constantly collecting new marketing data are significant. Furthermore, when a survey is conducted, a company must predict which issues will be important. Often, the predicted issues are shown to be unimportant and other issues must be presented in the survey. The mistake in the selected survey questions requires the expenditure of significant additional time and money.

In the prior art, many methods have been developed to quickly and inexpensively obtain marketing data by surveying customers. Many of these systems are computer based. Accordingly, questions can be selectively added to or removed from the survey when desired. Such prior art systems are exemplified by U.S. Pat. No. 5,893,075 to Plainfield, entitled, Interactive System And Method For Surveying And Targeting Customers; and U.S. Pat. No. 5,619,558 to Jheeta, entitled ATM Segment Of One Marketing Method.

Once a survey is conducted, the data derived from the answers to the survey must be analyzed. In the prior art, there exist many different systems that are used to analyze marketing data. Such prior art systems are exemplified by U.S. Pat. No. 5,893,098 to Peters, entitled, System And Method For Obtaining And Collecting Survey Information From A Plurality Of Computer Users; and U.S. Pat. No. 5,265,244 to Ghosh, entitled, Method And System For Facilitating Processing Of Statistical Inquires On Stored Data Accessible Through A Data Access Structure. However, such systems are designed to process data collected from a single survey by a single company.

A need exists for a survey system that continuously collects survey information on a wide variety of topics, wherein a company can selectively review selected portions of the collected data on an as needed basis. As such, a company need not commission a new marketing survey each time it needs new marketing data or fresh marking data. Similarly, a company need not predict what issues in a survey will be important prior to drafting the survey questions. Rather a company simply extracts the data it needs from a continuously updated data bank of survey results. This need is met by the present invention as it is described and claimed below.

### SUMMARY OF THE INVENTION

The present invention is a system and method for providing customized marketing data to paying customers, without having to commission a new marketing survey for each customer. In the present invention system, a marketing survey is created for each of a variety of different industries. Each of the surveys is distributed to potential respondents over a computer network, such as the Internet™. The same computer network is used to collect survey answers from participating respondents. The received answers are used to create marketing databases for different industries. Since the marketing surveys are sent and received in a dynamic fashion, the data contained within each database is periodically updated over a predetermined period of time. Accordingly, the marketing data contained in each database is kept up to date.

Qualified customers are provided access to relevant databases. Each customer is provided the ability to create a customized data table that shows the relationship between answers of any two questions in the survey. First, a customer selects the two survey questions to be analyzed. Selected answers to the two selected questions are then set in a table as column titles and row titles. The survey data from the selected answers is then cross tabulated to fill in the table. By viewing the data in the data table, a customer can see the specific relationship between any two survey questions, thereby providing information that relates only to specific questions of the marketing survey that are of interest to that customer. As a result, up to data marketing data can be retrieved from the system without having to commission expensive dedicated surveys.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a block flow diagram illustrating a first section of the present invention system;

FIG. 2 is a block flow diagram illustrating a second section of the present invention system;

FIG. 3 is a block flow diagram illustrating the steps involved in executing Block 32 from FIG. 2;

FIG. 4 is a block flow diagram illustrating the steps involved in executing Block 38 of FIG. 3; and

FIG. 5 is an exemplary embodiment of a data table in accordance with the present invention.

### DETAILED DESCRIPTION OF THE INVENTION

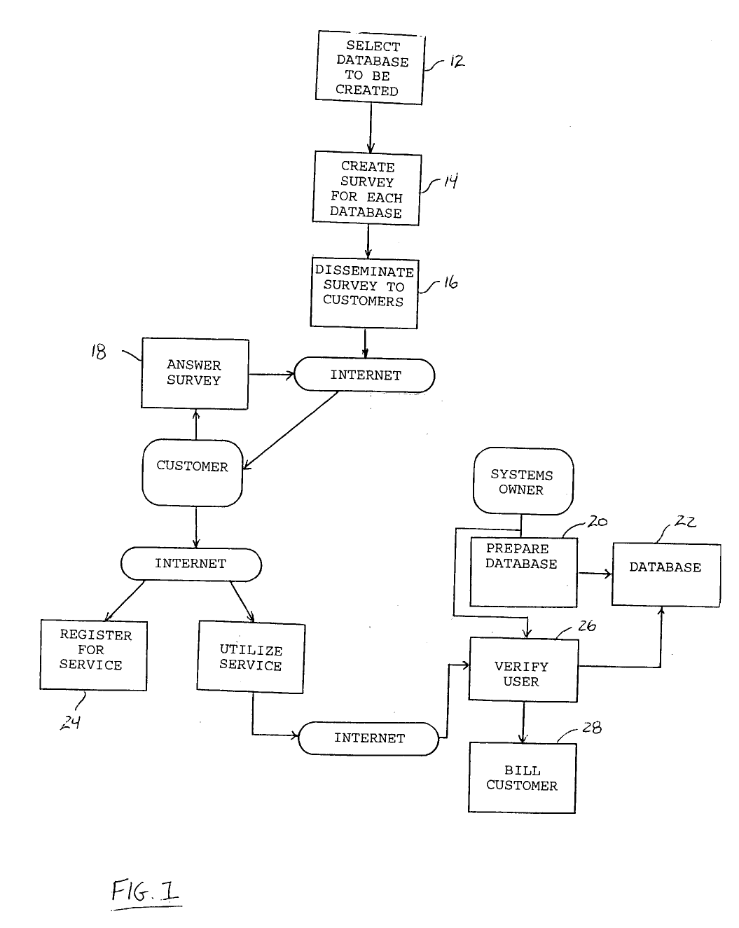

The present invention is a system and method for collecting marketing data and dynamically presenting that data to a variety of customers in a manner that is useful to each customer. Referring to FIG. 1, a first segment 10 of the overall system is shown. The segment 10 of the system illustrates the work preformed by the company operating the present invention system.

The present invention system creates databases of marketing data that are made available to customers on a subscription or other pay-for-service basis. As is indicated by Block 12 in FIG. 1, the first step is for the system owner to decide for what industries marketing data will be collected. For example, the system owner may want to collect data on telecommunication services, that can be sold to telecommunications providers. Alternatively, the system owner may want to collect information on health care that can be sold to heath care providers or information regarding a children's play habits that can be sold to toy manufacturers. The industries for which marketing information can be collected is only limited by the number of industries that exist. As the present invention system expands in popularity, alternative topics can be added to the system.

For each industry for which data will be collected, a separate database is created. The database contains answers to specific survey questions that are directed to the selected industry. Accordingly, for each database to be created, the system operator first develops a survey of questions that will produce data for that database. This is indicated by Block 14 in FIG. 1. The survey questions contain many of the standard questions used for each industry every time a survey is conducted. Standard questions include a variety of customer satisfaction questions, quality questions, and the like. The survey questions, however, may also contain a variety of specific questions that may only be useful to a minority of participants in the targeted industry.

Once a survey for each selected industry is prepared, the survey is answered by customers. In the preferred embodiment, the survey is sent to customers, via a computer network. As is indicated by Block 16, the survey can be answered by customers on the Internet™. The survey can be made available at different websites and various incentives, such as free computer access time or the like, can be used to help entice people to answer the survey. For example, if a survey of healthcare patients is created, this survey could be linked to various medical websites that are frequented by health care patients.

As customers answer the prepared survey, the survey answers are collected by the system operator over the Internet™. This is shown by Block 18 in FIG. 1. As indicated by Block 20, the system owner continuously collects the survey results and prepares a database 22 that contains the various responses to the survey.

Customers utilize the system by opening an account with the system owner, as is indicated by Block 24. Once an account is opened, the customer is free to access the system over the Internet™. When a customer accesses the system over the Internet™, the customer's registration status and identification are first checked. This is indicated by Block 26. Once a customer is validated, that customer is billed in accordance with the amount of time the customer uses the system or the amount of information obtained from the system. If the customer utilizes the system on a subscription basis, the customer need only pay a predetermined subscription fee to access the system. The step of billing the customer is indicated by Block 28.

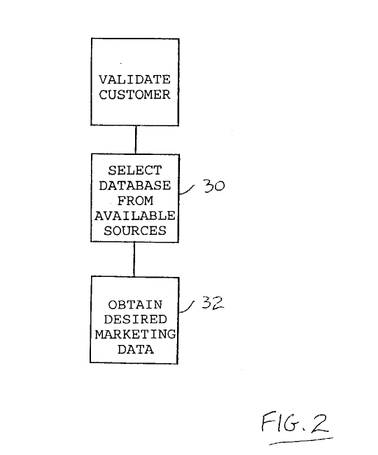

Referring to FIG. 2, it can be seen that once a valid customer is given access to the various databases in the system, that customer selects a database 22 that contains the marketing data being sought. This is shown by Block 30. As indicated by Block 32, the customer then dynamically obtains customized statistics from the accessed database that suit the customer's wants and needs.

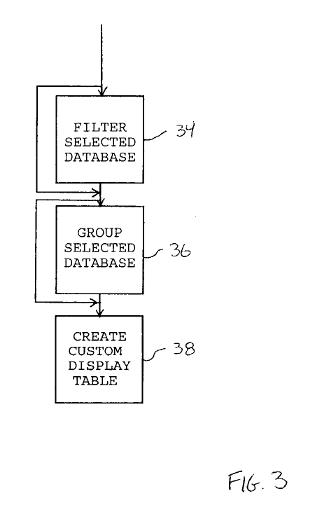

Much of what is unique about the present invention system is how a customer obtains customized data from a selected database, as is represented by Block 32. FIG. 3, shows the substeps involved in a customer obtaining desired data from a selected database. The customer can immediately obtain customized statistical data which indicates the relationship between any of the variables included in the database. Referring to FIG. 3, it can be seen that when a customer accesses a specific database, they may first customize the database by either filtering the database (Block 34) or grouping the database (Block 36). To filter the database, a customer can enter specific data criteria that is used to filter the data contained in the selected database. Only data in the database meeting the filter criteria will be accessed. For example, suppose a database being accessed contains telecommunications data. A customer can filter the database by entering specific filter criteria. The database can be filtered by eliminating all survey questions not answered by a U.S. resident. Alternatively, the database can be filtered by eliminating all survey questions by customers who do not use AT&T as their telecommunications provider. The possible filter criteria depend upon the questions and answers that are used in the survey that produced the selected database. Any survey question or survey answer can be used to filter the data in the database. The questions used in the survey can be dynamically generated in a filter list which is accessible on the computer screen by the user of the system. As such, a customer using the system can view a list of the questions used to create a specific database. That user can also view the possible answers for each of those questions. Any question or any answer to a question can then be used as a filter for the database.

In addition to filtering the database, a customer accessing a database can also group the data contained within that database. The step of grouping selected data is indicated by Block 36 in FIG. 3. Grouping is a type of reverse filtering process. Instead of eliminating data due to specific criteria, data in the database can be grouped together according to specific criteria. For example, by using grouping, a system user can group together data collected from all survey respondents that are male, left handed, satisfied with their mother's cooking or any other selected criteria or demographic. Of course, the choices of selected criteria used in the grouping process must be selected from the survey questions and answers used in the development of the database. The questions and possible answers used in the survey can be dynamically generated in a list which is accessible on the computer screen by the user of the system. As such, a customer using the system can view a list of the questions used to create a specific database. That user can also view the possible answers for each of those questions. Any question or any answer to a question can then be used as a grouping criteria for the database.

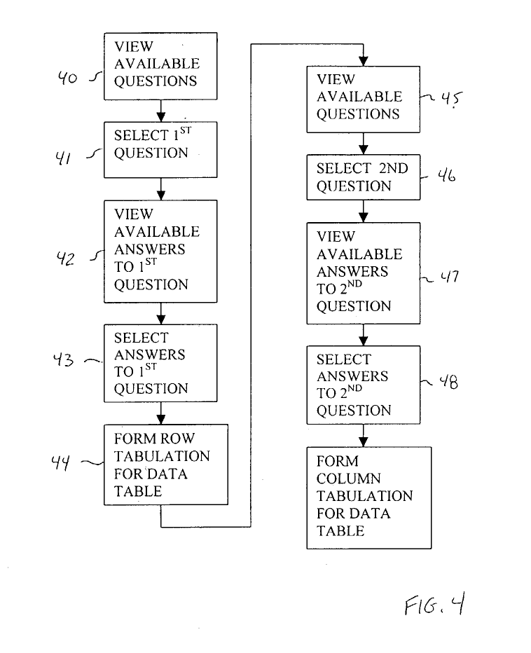

After a customer has preliminarily screened the data in a selected database, using the filtering and or grouping techniques, a customer creates custom display tables that contain the empirical data they desire. The creation of custom data tables is indicated by Block 38 in FIG. 3. The substeps involved in creating a custom display table is presented in FIG. 4.

The purpose of the creating a custom display table is to provide a user the ability to review the relationships between any two questions or answers contained in the remaining data of the filtered and/or grouped database. Referring to FIG. 4, it can be seen that to create a custom data table that illustrates the relationship between the answers of two survey questions, a user must first select a first survey question. As is indicated by Block 40, a user can view all the questions still available in a selected database. Since the data of the selected database may have been filtered and/or grouped, the remaining data remaining to choose from is most likely smaller than that of the originally selected database. A user views the questions that are still remaining in the database after the filtering and grouping processing steps. As is indicated by Block 41, the user then selects a first question, herein referred to as the first selected question. As is indicated by Block 43, a user then views all of the answers that are available for the first selected question. Some of the possible answers to the first selected question may not be available for selection if they were removed from consideration by the filtering and/or grouping processing steps.

Once a user selects the first selected question from the filtered and/or grouped database and selects an available answer to the first selected question , the first selected question is used to title a custom data table and the answers to the first selected question are used to create the row captions of the custom data table. See Block 44.

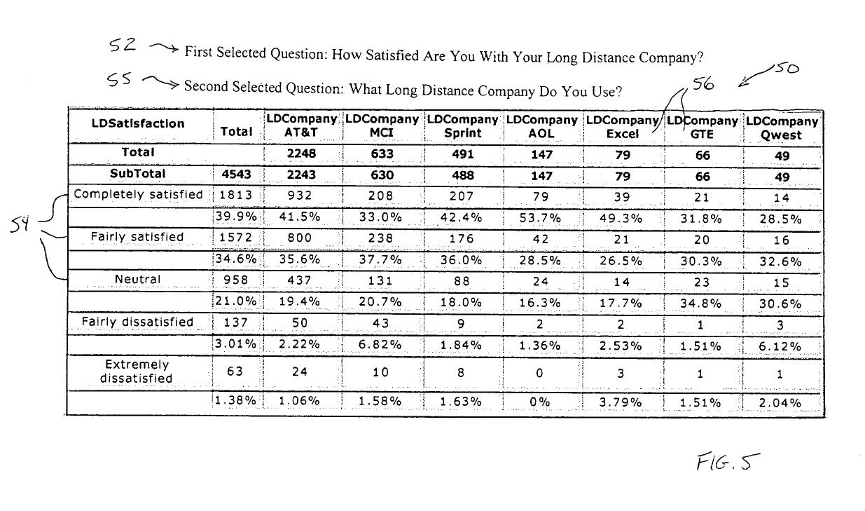

Referring briefly to FIG. 5, an exemplary custom data table 50 is shown. In this example, the custom data table 50 created from a database that contains information about telecommunication providers. The first selected question 52 selected to title the custom data table is “Are you satisfied with your long distance company?” This survey question had five possible available answers 54, which are “completely satisfied”, “fairly satisfied”, “neutral”, “fairly dissatisfied” and “extremely dissatisfied”. The possible answers 54 to the first selected question 52 are made the row titles of the data table 50.

The user of the system need not use all five answers to the survey question. Rather, the user of the system may only be interested in respondents who are below neutral or above neutral. Accordingly, it should be understood that a user can select any or all of the possible answers to a question as the row headings in the data table 50.

The first selected question 52 is used to title the custom data table 50 and the answers to the first selected question 52 are used to create the row titles of the custom data table 50. The column data for the custom data table 50 must now be selected.

Returning to FIG. 4, it can be seen that the selection of the column data for the custom data table begins at Block 45. In accordance with Block 45, a user again views all the questions still available in a selected database. Since the data of the selected database may have been filtered and/or grouped, the selections may be purposely limited. A user views the questions that are still remaining in the database after the filtering and grouping processing steps. As is indicated by Block 46, the user then selects a second question, herein referred to as the second selected question. As is indicated by Block 47, a user then views all of the answers that are available for the second selected question. Some of the possible answers to the second selected question may not be available for selection if they were removed from consideration by the filtering and/or grouping processing steps.

Once a user selects the second selected question from the filtered and/or grouped database and selects an available answer to the second selected question , the answers to the second selected question are used to caption the columns of the custom data table.

Referring again to the custom data table 50 illustrated in FIG. 5, it will be understood that the second selected question 55 was “Who is your long distance provider?” The second selected question 55 had seven possible available answers 56, which correspond to seven different long distance providers. The possible answers 56 to the second selected question 55 are made the column titles of the data table 50.

The user of the system need not use all seven answers to the second selected question. Rather, the user of the system may only be interested in respondents who have certain long distance providers. Accordingly, it should be understood that a user can select any or all of the possible answers to a question as the column headings in the data table 50.

Once the row headings and the column headings are selected, the system automatically cross tabulates the selected answer data and fills in the custom data table with the appropriate information from the selected database.

The exemplary data table 50 of FIG. 5 is used to illustrate how a customer can obtain specific marketing information by selectively reviewing the relationships between any two survey questions. A customer can obtain the data regarding the relationship between any two selected questions used in a survey. The answers to those two selected questions can be filtered, grouped and otherwise customized prior to the answers being used to crate a customized data table. In this manner, any customized data table crated by a user will contain only relevant information. The result is that customers can obtain the same empirical data from the present invention system that they otherwise would only be able to obtain by commissioning a customized marketing survey. In addition, a customer can obtain information dynamically and immediately. Customers can examine any question variable and determine the relationship between question variables without having to reconduct a survey. When a user selects questions to be compared, they see the data immediately, rather than waiting several days for the delivery of printed results.

Customers will pay to utilize the present invention system on a subscription or per diem basis. The cost of using the system is far less expensive than commissioning custom marketing surveys. Accordingly, the present invention system provides cost savings to its customers.

It will be understood that the various figures described above illustrate only one exemplary embodiments of the present invention. A person skilled in the art can make numerous alterations and modifications to the shown embodiment that function in an equivalent manner to the embodiment shown and described. For example, the topics of the various databases can be directed to any industry. Furthermore, the questions used to produce the databases can be any question that produces useful marketing data. Alternatively, it should be understood that the format of the data table of FIG. 5 can also be varied into many other types of tables and spreadsheet formats. All such modifications are intended to be included within the scope of the present invention as defined by the appended claims.

What is claimed is:

1. A method of creating a customized data table from a database containing collected answers to a survey questions, said method comprising the steps of:
selecting a first question from the survey questions;
selecting possible answers to said first question;
titling rows of a data table with said possible answers selected for said first question;
selecting a second question from the survey questions;
selecting possible answers to said second question;
titling columns of the data table with said possible answers;
cross-tabulating data from the database corresponding to said answers selected for said first question and answers selected for said second question to complete said data table.

2. The method according to claim 1, further including the step of filtering said answers to said first selected question, thereby creating filtered answer data that contains only some of said answers to said first selected answer.

3. The method according to claim 2, wherein said step of selecting possible answers to said first question includes selecting possible answers from said filtered answer data.

4. The method according to claim 2, wherein said step of filtering said answers to said first selected question includes the substeps of selecting an answer criteria and eliminating and answer not meeting said answer criteria when creating said filtered answer data.

5. The method according to claim 1, further including the step of grouping said answers to said first selected question, thereby creating grouped answer data that contains only some of said answers to said first selected answer.

6. The method according to claim 5, wherein said step of selecting possible answers to said first question includes selecting possible answers from said grouped answer data.

7. The method according to claim 5, wherein said step of grouping said answers to said first selected question includes the substeps of selecting an answer criteria and adding only answers meeting said answer criteria to said grouped answer data.

8. The method according to claim 1, further including the step of filtering said answers to said second selected question, thereby creating filtered answer data that contains only some of said answers to said second selected answer.

9. The method according to claim 8, wherein said step of selecting possible answers to said second question includes selecting possible answers from said filtered answer data.

10. The method according to claim 8, wherein said step of filtering said answers to said second selected question includes the substeps of selecting an answer criteria and eliminating and answer not meeting said answer criteria when creating said filtered answer data.

11. The method according to claim 1, further including the step of grouping said answers to said second selected question, thereby creating grouped answer data that contains only some of said answers to said second selected answer.

12. The method according to claim 11, wherein said step of selecting possible answers to said second question includes selecting possible answers from said grouped answer data.

13. The method according to claim 12, wherein said step of grouping said answers to said second selected question includes the substeps of selecting an answer criteria and adding only answers meeting said answer criteria to said grouped answer data.

14. A method of providing marketing data to customers, comprising the steps of:
preparing a marketing survey containing a plurality of survey questions;
distributing said survey to individuals over a computer network;
collecting answers to said survey questions over said computer network to create a database;
enabling customers to access said database through a computer network;
providing customers the ability to view a relationship between any two survey questions contained in said survey by providing a table that cross-tabulates answers to any first selected question of said survey with answers to any second selected question of said survey.

15. The method according to claim 14, wherein said step of providing customers the ability to view a relationship between any two survey questions includes displaying all of said survey questions to a customer and enabling the customer to select said first selected question and said second selected question from said survey questions.

16. The method according to claim 14, wherein said step of providing customers the ability to view a relationship between any two survey questions includes providing a data table where answers to said first selected question are cross tabulated with answers from said second selected question.

17. The method according to claim 15, wherein said computer network includes the Internet™.

18. A method of maintaining accurate marketing data for a plurality of different industries, comprising the steps of:
producing a marketing survey for each of said plurality of industries;
periodically disseminating each said marketing survey to potential respondents during a predetermined period of time;
periodically collecting answers to each said marketing survey during said predetermined period of time;
producing a database of survey answers corresponding to each said marketing survey;
providing access to each said database to customers requiring marketing survey data in the industry corresponding to each said database;
enabling customers to customize data contained in a selected database by cross tabulating answers to any two selected question in said marketing survey.

19. The method according to claim 17, wherein said step of enabling customers to customize data includes providing customers the ability to filter data by eliminating data corresponding to specific survey questions.
